(19) United States
(12) Patent Application Publication
(10) Pub. No.: US 2009/0094678 A1
(43) Pub. Date: Apr. 9, 2009

(54) Mulimode device

(75) Inventors: Matti Floman, Kangasala (FI); Kimmo Mylly, Ylojarvi (FI); Marko Ahvenainen, Ruutana (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/286,900

(22) Filed: Oct. 1, 2008

Related U.S. Application Data
(60) Provisional application No. 60/997,984, filed on Oct. 5, 2007.

(51) Int. Cl. G06F 21/00

(52) U.S. Cl. 726/2

(57) ABSTRACT

A mode indexing table is used for listing the available modes in a multimode device. From information in the mode indexing table, a host recognizes the modes as listed in the table. The host has a mandatory initialization mode using a known technique, such that the device can enter into an initialization mode directly or via a boot function. During initialization, the host receives the remaining part of the table from the multi-mode device and recognizes the functionality of each of the listed modes in the table. Among the available modes, some modes are allowed to access data of other modes according to the level of access. The multimode device has some commands that can be used for direct mode switching.

This application is based on and claims benefits to U.S. Provisional Application Ser. No. 60/997,984, filed Oct. 5, 2007.

### FIELD OF THE INVENTION

The present invention relates generally to multimode devices and, in particular, the controller of the multimode devices.

### BACKGROUND OF THE INVENTION

Multimode devices, such as mass memory devices and IO devices, have a plurality of operation modes. For example, a MultiMediaCard (MMC) has a normal or MMC mode, a secure mode, etc. After boot and/or initialization, an MMC would typically enter into the normal mode. If it is desirable to go to another mode, a switch command can be used to change from the normal mode to a specified different mode. Typically different modes are separated from each other with a “wall” and data of different modes is usually not available to each other except for data in the commonly shared registers. According to the MMC/eMMC specification, in order to switch the mode of operation of a selected memory card, the SWITCH command (CMD6) is used. The SWITCH command can also be used to modify the extended card-specific data (EXT_CSD) register. Thus, the SWITCH command can be used to change the command set or to write the EXT_CSD register to select a power class or buswidth of high speed mode, for example. The MMC/eMMC specification also defines commands for checking a status of an addressed card (CMD13), and for reading CSD/EXT_CSD register of the card (CMD9/CMD8).

Prior art MMC architectures are shown in FIGS. 1a and 1b. In the MMC architecture as shown in FIG. 1a, the MMC has a plurality of registers: CID (Card Identification number, a card individual number for identification.), RCA (Relative Card Address, is the card system address, dynamically assigned by the host during initialization.), DSR (Driver Stage Register, to configure the card's output drivers), CSD (Card Specific Data, information about the card operation conditions) and OCR (Operation Conditions Register, used by a special broadcast command to identify the voltage type of the card). In the MMC architecture as shown in FIG. 1b, the MMC has an additional register EXT_CSD to provide information about the card capabilities and selected modes.

### SUMMARY OF THE INVENTION

The present invention provides a mode indexing table for listing the available modes in a multimode device. The number of modes is only limited by the data field size. From information in the mode indexing table, a host recognizes the modes as listed in the table. The host has a mandatory initialization modes using a known technique (device can enter initialization mode directly or via a boot function). During initialization, the host receives the remaining part of the table from the multi-mode device and recognizes the functionality of each of the listed modes in the table.

According to the present invention, among the available modes, some modes are allowed to access data of other modes according to the level of access. The multimode device has some commands that can be used for direct mode switching.

Thus, the first aspect of the present invention is an apparatus, which comprises:

a listing of a plurality of modes, wherein at least one of the plurality of modes is assigned a level of access, such that when the apparatus is operated in said one mode, said one mode is allowed to access data of other modes according to the level of access. The listing is provided in a register or in a memory section. The plurality of modes comprise a default mode and a plurality of further modes.

According to one embodiment of the present invention, mode switching from the default mode to one of the further modes can be carried out by a first command, and mode switching between said further modes can be carried out by a second command. The first command and the second command can be stored in a plurality of registers. The first command is a switch command and the second command is a send-status command, or a send-data command, for example.

According to one embodiment of the present invention, an index argument is provided in one of said further modes pointing to a different one of said further modes, so as to allow mode switching from said one further mode to the different one of said further modes based on the index argument.

According to one embodiment of the present invention, the apparatus is configured to operate in the default mode after an initialization procedure.

According to various embodiments of the present invention, the apparatus is configured to couple with a host device and to provide information to the host device so as to allow the host device to change one of the plurality of modes to another one of the plurality of modes based on the information.

According to one embodiment of the present invention, the plurality of modes further comprises a different mode which can only be accessed with authorization.

Thus, the apparatus, according to various embodiments of the present invention, comprises:

means for listing a plurality of modes in a multimode device, wherein at least one of said plurality of modes is assigned a level of access, such that when the multimode device is operated in said one mode, said one mode is allowed to access data of other modes according to the level of access; and

means for providing a first command and a second command in the multimode device for mode switching such that one of the first command and the second command can cause switching from one of said plurality of modes to a different one of said plurality of modes. The plurality of modes comprise a default mode and a plurality of further modes, and wherein the first command is arranged for mode switching between said default mode and one of said further modes, and the second command is arranged for mode switching between said further modes.

The apparatus further comprises means for causing the multimode device to operate in the default mode after an initialization procedure.

The apparatus can be a multimode device, such as a memory and IO device.

The second aspect of the present invention is a method, comprising:

listing a plurality of modes in a multimode device, and

assigning a level of access to at least one of the plurality of modes, such that when the multimode device is operated in said one mode, said one mode is allowed to access data of other modes according to the level of access.

The plurality of modes comprise a default mode and a plurality of further modes. Accordingly, a first command is arranged for mode switching between said default mode and one of said further modes, and a second command is arranged for mode switching between said further modes.

According to one embodiment of the present invention, the method further comprises:

causing the multimode device to operate in the default mode after an initialization procedure;

coupling the multimode device to a host device; and

providing information to the host device so as to allow the host device to change one of the modes to another one of the modes based on the information.

According to one embodiment of the present invention, the method further comprises:

providing an index argument in one of said further modes pointing to a different one of said further modes, so as to allow mode switching from said each one further mode to the different one of said further modes based on the index argument.

The present invention will become apparent upon reading the description taken in conjunction with FIGS. 4 to 6.

### BRIEF DESCRIPTION OF THE DRAWINGS

FIG. 1a shows a prior art MMC architecture.

FIG. 1b shows another prior art MMC architecture.

FIG. 2 shows a partial table of commands.

FIG. 3 shows an exemplary MMC system.

FIG. 4 shows the initialization flow of a prior art multi-mode device.

FIG. 5 shows the switching between modes after initialization, according to one embodiment of the present invention.

FIG. 6 shows an example of the mode indexing table.

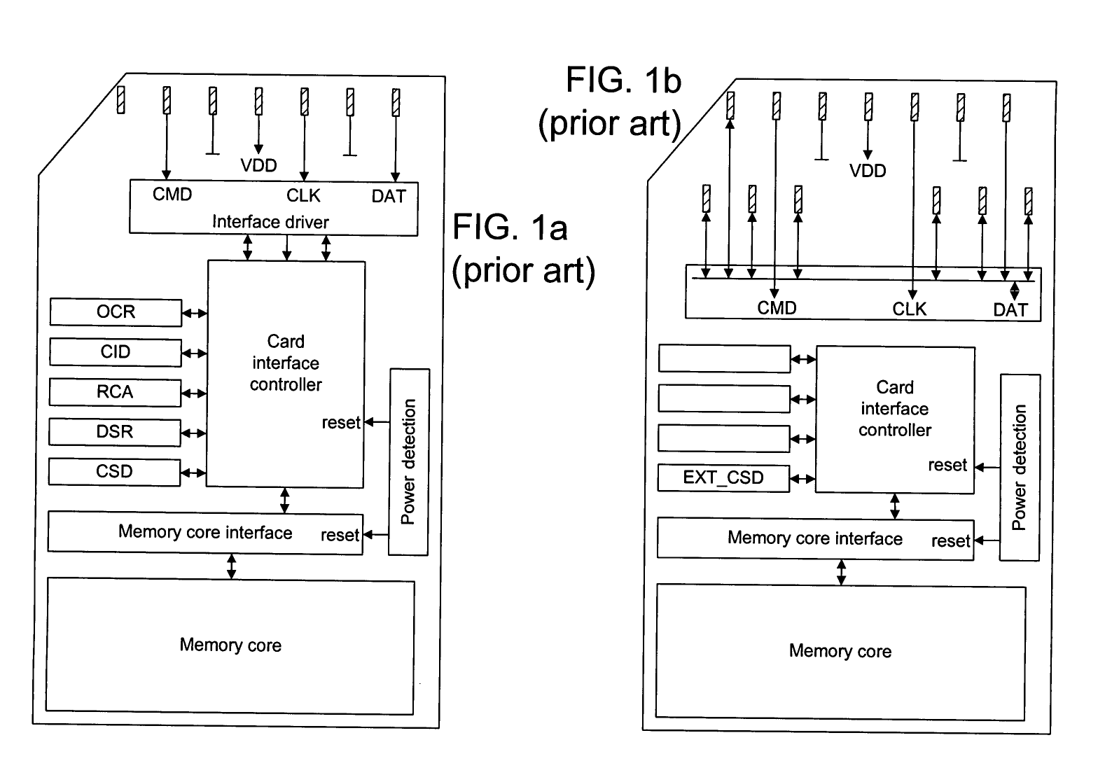

### DETAILED DESCRIPTION OF THE INVENTION

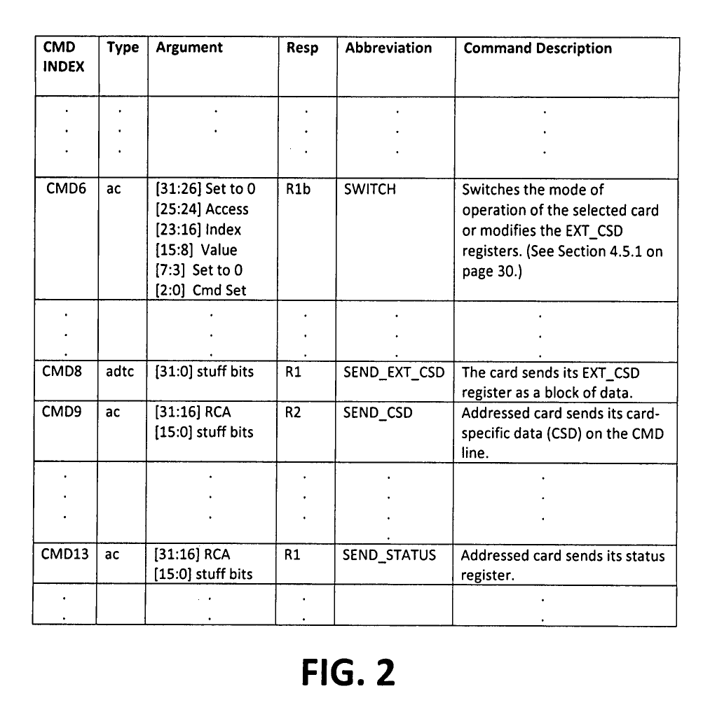

Typically, a mass memory device, such as the MMC, has a mode indexing table listing supported modes. Each mode has one or more commands. For example, in the ATAonMMC mode, the involved commands are e.g. CMD39 and CMD56. Some commonly known modes are Secure Mode, Normal Mode and ATAonMMC mode. A table listing some of the commands is shown in FIG. 2.

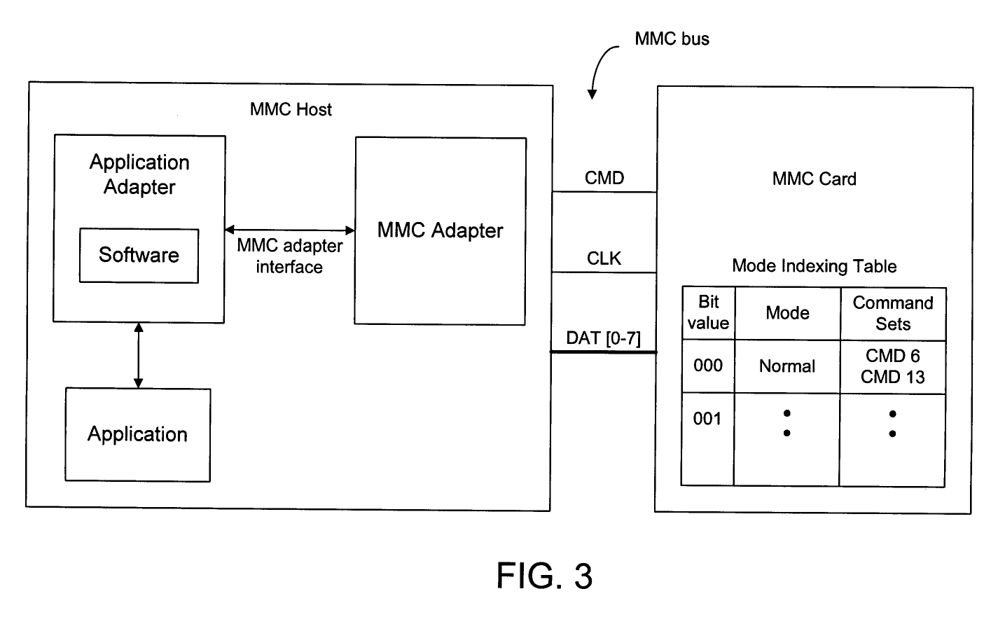

When a host is coupled to an MMC, the host recognizes the modes as listed in the mode index table by using mode identification table information. A typical MMC system is shown in FIG. 3. As shown in FIG. 3, the MMC host typically has an MMC adapter to receive the MMC bus of an MMC card. Depending on the application in the MMC host, the host has an application adapter, which is linked to the MMC adapter by an MMC adapter interface. The MMC adapter and the application adapter are part of a component generally referred to as the MMC controller. The application adapter has specific software to perform application-oriented tasks. The host can be a mobile phone, a camera, a PDA, a PC or the like. The host can also be an appliance, such as a TV set, a car radio, a home theater system, etc. In a host such as a mobile phone, the application can be a navigation system. In a more complex MMC system, a DMA (Direct Memory Access) controller/bus bridge is also used in a hardware system.

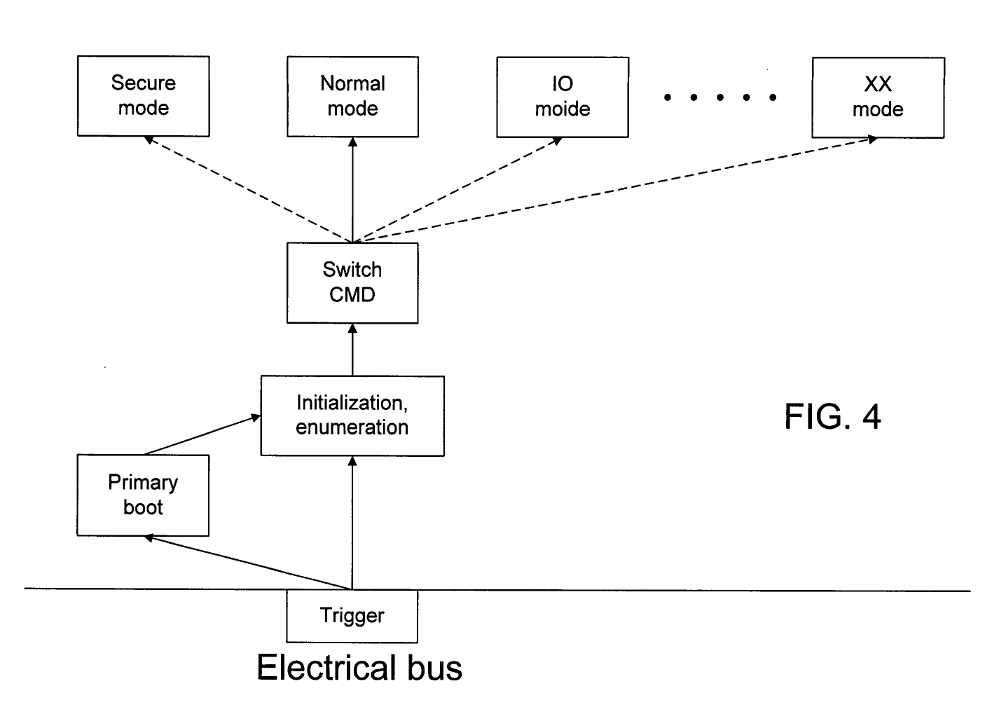

In a mass memory device, such as an MMC, an ATA device, an SCSI device, and a device with sector access, the normal mode is mandatory. The SWITCH command may be used to enter another mode from the normal mode, and the device initialization flow is shown in FIG. 4. As shown in FIG. 4, after the boot and/or initialization procedure, an MMC goes to the Normal Mode (Memory Card Mode). From the Normal Mode, it is possible to switch to another mode with the SWITCH command. In a prior art multimode device, there are several defined modes. There is very limited flexibility in defining modes from the point of view of a host.

The present invention provides a mode indexing table for listing the available modes in a multimode device. The number of modes is only limited by the data field size. Among the available modes, some modes are allowed to access data of other modes according to the level of access. The multimode device has some commands that can be used for direct mode switching.

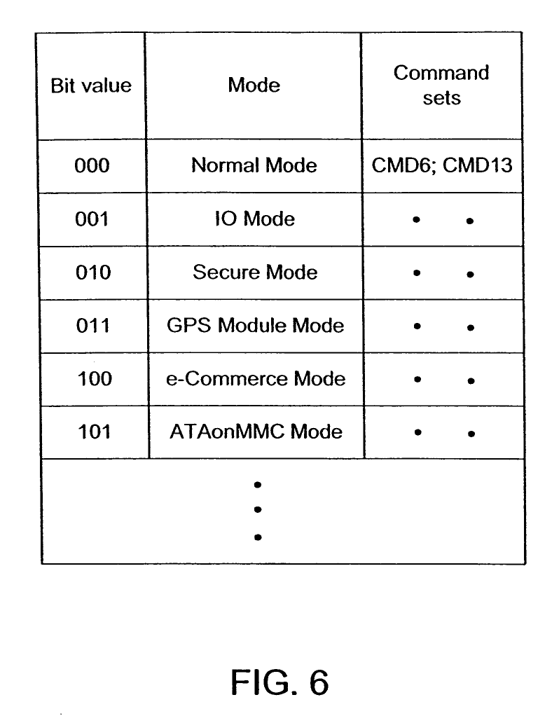

From information in the mode indexing table, a host recognizes the modes as listed in the table. The host may utilize the boot function or not. After the host is up and running it initializes the bus of the multimode device and the multimode device enters an idle/common mode; this mode can also be an initialization mode. This mode is common for all devices connected to this bus, typically a simplified command set and state diagram applies. From this common mode, the host controls the multimode device to enter a supported additional mode(s) per the index table information. For example, the host can have a standard mode for initialization using a known technique. During initialization, the host receives the remaining part of the table from the multimode device and recognizes the functionality of each of the listed modes in the table. A non-limiting example of a mode indexing table is shown in FIG. 6.

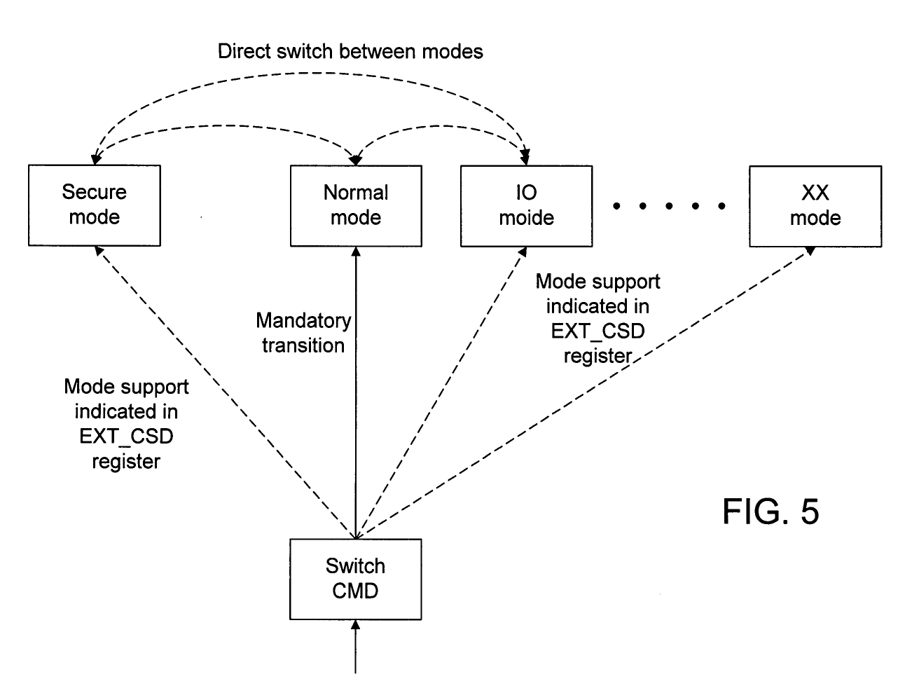

According to one embodiment of the present invention, in addition to the capability of going from one mode to another using a switch command, such as the SWITCH command according to the MMC/eMMC specification, it is also possible to carry out direct switching between modes. For example, it is possible to go directly from Secure Mode to IO mode. As shown in FIG. 5, after the boot and/or initialization procedure, the multimode device goes to Normal Mode in a mandatory transition using the switch command. Using the switch command after the mandatory Normal Mode, it is also possible to switch to the Secure Mode using the switch command as indicated in a multimode device register (such as the EXT_CSD register according to the MMC/eMMC specification). Likewise, it is possible to switch from Normal Mode or Secure Mode to IO mode or another mode that has the support as indicated in the register.

According to embodiments of the present invention, each of the modes has a set of common mandatory commands and the commands have an index argument pointing to a certain mode. For example, one of the modes has a minimum set of two commands: a switch command such as the SWITCH command (CMD6) and the send-status command such as the SEND_STATUS command (CMD13) according to the MMC/eMMC specification. The index argument pointing to another mode can be two lowest legacy stuff bits in the send-status command, for example. Other commands such as send data commands can also be used in direct data transfer between modes by using the legacy stuff bits in the arguments of those commands. Functionally and structurally, the send data commands can be similar to CMD8 and CMD9 of the MMC/eMMC specification. It should be understood that the MMC/eMMC commands such as CMD6, CMD8, CMD9, CMD13 and their arguments have been used to illustrate how the direct switching between modes, according to one embodiment of the present invention, can be carried out. The use of commands, according to one embodiment of the present invention, is not limited to those commands and other commands according to the MMC/eMMC specification. The commands to be used to carry out some embodiments of the present invention can be partially or completely different from the MMC/eMMC commands.

According to one embodiment of the present invention, it is possible that some modes cannot be reached by direct switching. This means there is an option to block the switching to a specific mode. Block switching can be done in the way that read/write/switch command will have a longer argument to include a password field and a mode index. The password and mode index will be checked during mode switching, for example. Alternatively, only the mode index, but not the password, is included in the argument of the relevant commands. When the specific mode is activated, it requests the password.

According to one embodiment of the present invention, each mode may be allowed to have a certain level of access to another mode. For example, each mode would be allowed to read register data of a certain mode as a minimum level of access. When a mode has a maximum level of access, it is able to change content of register data of all other modes, or to change the data stored in the mass memory data controlled to other modes. The access level for each mode can be specified in the mode table. As an option, each of the modes in the mode table or the mode table itself can be password protected. Data sharing between modes can be allowed in a controlled way. For example, a non-critical mode may not be allowed to read the data of a critical mode, or may be allowed only to read the data of a critical mode. A trustworthy mode may have access to the data in all other modes and may even be allowed to modify data in certain modes. A certain mode may be allowed to write the registers in another mode. For example, IO mode can be defined to have register X which includes the speed to be used during data transfer, but the defined speed can be set up by another mode. Among the commonly used modes in a mass memory device, GPS module mode is an example of a non-critical mode. GPS module mode provides its data to all other modes, but it may not be allowed to access data from other modes. In contrast, e-Commerce Mode is a critical mode. Such a mode is trustworthy and may have the highest level of protection.

According to one embodiment of the present invention, the registers in a mass memory device can be classified into two or more types. For example, some registers are mode-specific registers which can have any structure as defined in a mode's datasheet. The registers of the other type have a common register structure with mode specific indexing.

According to one embodiment of the present invention, the number of modes can be assigned or specified for a memory device so long as the data field size allows such assignment. This means that the number of modes is not fixed but flexible. The order of the modes in a device can be changeable. For example, Device A has only one mode: 00 Normal Mode; Device B has two modes: 00 Normal Mode and 01 Secure Mode; Device C has three modes: 00 Normal Mode; 01 IO Mode and 10 Secure Mode.

Thus, various embodiments of the present invention provide a method of mode switching in a multimode device wherein some modes are allowed to be switched directly to another mode. In the device, according to embodiments of the present invention, the number of modes is not fixed but flexible and the order of the modes may be changeable. It is possible to share data between modes in a controlled way. Among the various modes in a multimode device, data in a non-critical mode can be accessed by another mode without a password. In contrast, the access to a critical mode is restricted and may require a password.

The MMC/eMMC commands such as CMD6, CMD8, CMD9, CMD13, have been used to illustrate how direct switching between modes, according to embodiments of the present invention, can be carried out. It should be noted that at least some of the embodiments of the present invention may not be backward compatible with MMC/eMMC specification. Therefore, it should be understood that the use of various commands is not limited to the switching command and the status command as described herein.

In sum, the present invention provides a method and an apparatus, wherein the apparatus includes means for providing a listing of a plurality of modes, wherein at least one of the plurality of modes is assigned a level of access, such that when the apparatus is operated in said one mode, said one mode is allowed to access data of other modes according to the level of access. The listing can be provided in a register or a in a memory section. The plurality of modes includes a default mode and a plurality of further modes. The apparatus can be configured to operate in the default mode after an initialization process, or has means for causing the apparatus to operate in the default mode after initialization. The apparatus includes means for providing a first command and a second command for mode switching. As such, mode switching from the default mode to one of the further modes can be carried out by a first command, and mode switching between the further modes can be carried out by a second command. The first command is a switch command and the second command can be a send-status command or a send-data command, for example.

The apparatus is also configured to couple with a host device and to provide information to the host device so as to allow the host device to change one of the plurality of modes to another one of the plurality of modes based on the information. An index argument is provided in one of the further modes pointing to a different one of the further modes, so as to allow mode switching from said one further mode to the different one of said further modes based on the index argument. The plurality of modes may include a different mode which can only be accessed with authorization.

Accordingly, the method, according to various embodiments of the present invention, includes

listing a plurality of modes in a multimode device, and

assigning a level of access to at least one of the plurality of modes, such that when the multimode device is operated in said one mode, said one mode is allowed to access data of other modes according to the level of access. The plurality of modes comprise a default mode and a plurality of further modes. Wherein mode switching between the default mode and one of the further modes can be carried out by a first command, such as a SWITCH command, and mode switching between the further modes can be carried out by a second command, such as a send-data command or a send-status command.

According to the present invention, the multimode device is configured for coupling to a host device; and for providing information to the host device so as to allow the host device to change one the modes to another one of the modes based on the information.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. An apparatus, comprising:
a listing of a plurality of modes, wherein at least one of the plurality of modes is assigned a level of access, such that when the apparatus is operated in said one mode, said one mode is allowed to access data of other modes according to the level of access.

2. The apparatus of claim 1, wherein said plurality of modes comprise a default mode and a plurality of further modes.

3. The apparatus of claim 2, wherein mode switching from said default mode to one of said further modes can be carried out by a first command, and mode switching between said further modes can be carried out by a second command.

4. The apparatus of claim 3, further comprising:
a plurality of registers for storing the first command and the second command.

5. The apparatus of claim 2, configured to operate in the default mode after an initialization procedure.

6. The apparatus of claim 1, configured to couple with a host device and to provide information to the host device so as to allow the host device to change one of the plurality of modes to another one of the plurality of modes based on the information.

7. The apparatus of claim 1, wherein the listing is provided in a register.

8. The apparatus of claim 1, wherein the listing is provided in a memory section.

9. The apparatus of claim 2, wherein an index argument is provided in one of said further modes pointing to a different one of said further modes, so as to allow mode switching from said one further mode to the different one of said further modes based on the index argument.

10. The apparatus of claim 3, wherein the first command is a switch command and the second command comprises one of a send-status command and a send-data command.

11. The apparatus of claim 2, wherein said plurality of modes further comprise a different mode which can only be accessed with authorization.

12. A method, comprising:
listing a plurality of modes in a multimode device, and
assigning a level of access to at least one of the plurality of modes, such that when the multimode device is operated in said one mode, said one mode is allowed to access data of other modes according to the level of access.

13. The method of claim 12, wherein said plurality of modes comprise a default mode and a plurality of further modes.

14. The method of claim 13, wherein a first command is arranged for mode switching between said default mode and one of said further modes, and a second command is arranged for mode switching between said further modes.

15. The method of claim 13, further comprising:
causing the multimode device to operate in the default mode after an initialization procedure.

16. The method of claim 12,
coupling the multimode device to a host device; and
providing information to the host device so as to allow the host device to change one of the modes to another one of the modes based on the information.

17. The method of claim 13, further comprising:
providing an index argument in one of said further modes pointing to a different one of said further modes, so as to allow mode switching from said one further mode to said different one further mode based on the index argument.

18. The method of claim 14, wherein the first command is a switch command and the second command comprises one of a send-status and a send-data command.

19. The method of claim 13, wherein said plurality of modes further comprise a different mode which can only be accessed with authorization.

20. An apparatus, comprising:
means for listing a plurality of modes, wherein at least one of said plurality of modes is assigned a level of access, such that when the multimode device is operated in said one mode, said one mode is allowed to access data of other modes according to the level of access; and
means for providing a first command and a second command for mode switching such that one of the first command and the second command can cause switching from one of said plurality of modes to a different one of said plurality of modes.

21. The apparatus of claim 20, wherein said plurality of modes comprise a default mode and a plurality of further modes, and wherein the first command is arranged for mode switching between said default mode and one of said further modes, and the second command is arranged for mode switching between said further modes.

22. The apparatus of claim 21, further comprising:
means for causing the apparatus to operate in the default mode after an initialization procedure.
